(19) United States
(12) Patent Application Publication
(10) Pub. No.: US 2002/0004830 A1
(43) Pub. Date: Jan. 10, 2002

(54) Method and system for providing engineering analysis tools in a distributed environment

(76) Inventors: Richard Hyatt, Richmond Hill (CA); Michael Hyatt, Toronto (CA)

Correspondence Address: BORDEN LADNER GERVAIS, LLP, 1000 - 60 QUEEN STREET, OTTAWA, ON, K1P 5Y7, CA

(21) Appl. No.: 09/846,316

(22) Filed: May 2, 2001

(30) Foreign Application Priority Data
May 2, 2000 (CA) 2,307,403

(51) Int. Cl. G06F 15/173; G06F 9/00

(52) U.S. Cl. 709/225; 709/100

(57) ABSTRACT

A system and method for providing data analysis tools in a distributed environment, such as the Internet. The method commences by receiving a service request from a client. Typically, the service request includes input data for submission to a requested analysis tool. A job is then created to provide a job identifier and the input data in a suitable format, such as XML, for transmission to a service provider hosting the requested analysis tool. Information relating to the job is stored in a database, and the job is then dispatched to an agent for delivery to the service provider hosting the requested analysis tool. Once processed by the service provider, the job results are returned to the agent, integrated to retrieve the output data, and the output data is transmitted to the client.

### FIELD OF THE INVENTION

The present invention relates to a method and system for providing data analysis tools and services. In particular, the present invention relates to a method and system for providing engineering analysis tools and services over a network, such as the Internet.

### BACKGROUND OF THE INVENTION

The analysis and modeling of data is an important component of most engineering projects. In today's complex engineering environment, computer aided modeling and analysis has become a standard practice, and most engineering professionals rely on computer generated analyses to accomplish their day to day work. In a typical engineering project, the analysis tools include calculators, converters, basic and complex data models, and other data analysis tools. Calculators and converters are frequently used by engineering professionals to convert units/systems of measure, to perform simple, single calculations such as calculating fluid flow, pressure loss, stress, load, and friction. Data models permit an engineer to perform more complex engineering analyses and to simulate a design's operation. Data models generally require more numerous data inputs and complex processing. Data models are commonly used for such applications as circuit design/analysis, dispersion modeling, fluid flow modeling, and hydraulic modeling. Other data analysis tools include charting and graphing software.

Generally, an engineer uses one or more handheld calculators, and/or a custom programmed general purpose computer, for performing simple calculations and conversions. To access more complex data models, an engineering firm must either develop programs in-house, which is costly and time-consuming, or purchase specialized software, which can be very expensive. The expense associated with purchasing and managing specialized application software, and hardware, can be prohibitive, particularly if an analysis tool is required infrequently.

Application service providers (ASPs) are a relatively new innovation on the Internet. An ASP is a service provider offering access to software applications, infrastructure, and related services over the Internet. Applications are not installed at the end user location, but are instead remotely installed, managed, and accessed on infrastructure provided by the ASP. ASPs permit users access to specialized applications, that would, otherwise, be too expensive to install and maintain. At present, ASPs typically provide access to applications that are proprietary to the particular ASP. However, engineering analysis tools have been developed by numerous, unrelated providers and the current ASP model means that an engineer seeking particular tools must locate and request services from numerous sources. Thus, while certain applications may be available on the Internet, they are not available, or searchable, at a single convenient location.

In addition, many highly specialized analysis tools have been developed by universities and government institutions, and must be run on very powerful supercomputers. These institutions do not generally operate as ASPs, and as a result, their applications are not available to the general user unless special permission has been sought and granted. This disadvantages both the engineer who could benefit from such analysis tools, and the institution that has developed the tool, but which does not reap any economic benefit from it.

It is therefore desirable to provide a method and system for providing and managing engineering analysis tools from multiple third party providers. It is further desirable that the tools can be accessed by a user through a single, convenient portal over the Internet.

### SUMMARY OF THE INVENTION

It is an object of the present invention to provide a method and system for providing data analysis tools in a distributed environment, such as the Internet, such that a user can access tools from multiple providers seamlessly at a single site.

In a first aspect, the present invention provides a method for providing data analysis tools in a distributed environment, such as the Internet. The method commences by receiving a service request from a client. Typically, the service request includes input data for submission to a requested analysis tool. A job is then created to provide a job identifier and the input data in a suitable format, such as XML, for transmission to a service provider hosting the requested analysis tool. Information relating to the job is stored in a database, and the job is then dispatched to an agent for delivery to the service provider hosting the requested analysis tool. Once processed by the service provider, the job results are returned to the agent, integrated to retrieve the output data, and the output data is transmitted to the client. According further embodiments of the present invention, the step of dispatching the job can also include balancing job loads between service providers.

According to a further aspect of the present invention, there is provided a system for providing data analysis tools in a distributed environment, such as the Internet. The system consists of a web server, manager, a dispatcher, an integrator and at least one agent. The web server receives service requests from clients, including input data, which the manager then creates into jobs. The dispatcher dispatches the jobs to agents for delivery to service providers hosting requested analysis tools. The integrator receives the results of the processing the job according to the analysis tool, extracts the output data, and sends the output data back to the client. In a presently preferred embodiment, the manager also includes markup means to markup the input data with XML, and a database for storing job and client information. In this embodiment, the dispatcher includes load balancing means to balance processing loads between service providers.

### BRIEF DESCRIPTION OF THE DRAWINGS

Preferred embodiments of the present invention will now be described, by way of example only, with reference to the attached Figures, wherein:

FIG. 1 is a block diagram of a system for providing data analysis tools in a distributed environment according to the present invention;

FIG. 2 is a block diagram of a client of the system of FIG. 1;

FIG. 3 is a block diagram of a software system installed on the client of FIG. 2;

FIG. 4 is a block diagram of a host of the system of FIG. 1; and

FIG. 5 is a flow chart of a method for providing data analysis tools in a distributed environment according to the present invention.

### DETAILED DESCRIPTION OF THE INVENTION

The following description will focus on the presently preferred embodiment of the present invention, which is operative in an Internet-connected environment, including, for example, machines operating under Microsoft® Windows environment and connected to an open network, such as the Internet. The present invention is not, however, limited to any particular one environment. Instead, as will be understood by those of skill in the art, the system and methods described herein can be advantageously applied to a variety of system and application software, operating on a variety of platforms, including the Macintosh® operating system, the Unix® operating system, and the like, and can apply to systems implemented on any wide area network (WAN), or local area network (LAN).

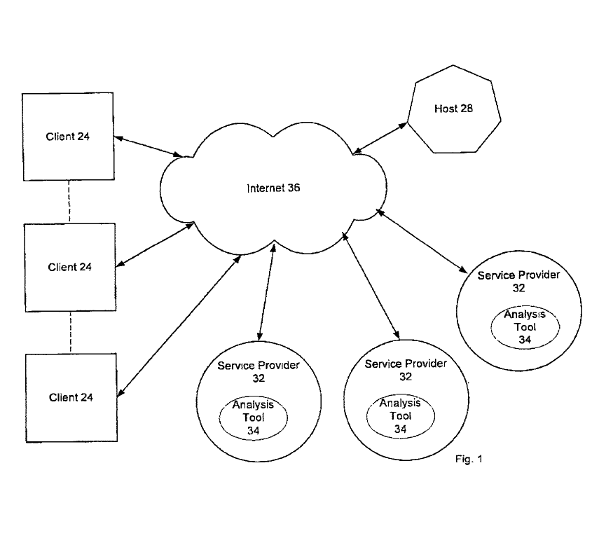

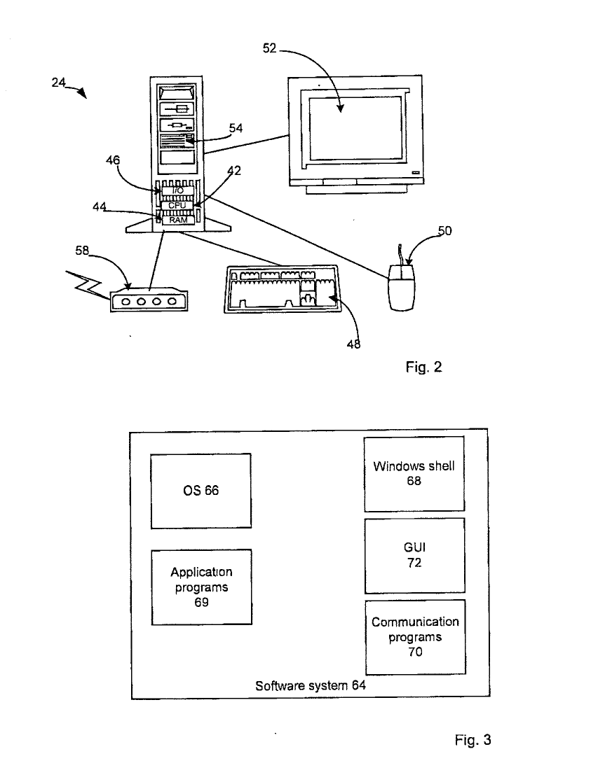

Referring to FIG. 1, a block diagram of the system of the present invention is shown, and generally referenced at 20. System 20 generally consists of client(s) 24, host 28, and service provider(s) 32 hosting analysis tools 34, interconnected via the Internet 36. As shown in FIG. 2, clients 24 are typically embodied on a general purpose computer, such as an IBM PC-compatible personal computer, operating as stand-alone machines or interconnected on a LAN. For example, in a LAN based environment, client 24 consists of a central processor 42, a main memory 44, such as conventional random access memory (RAM), an input/output controller 46, a keyboard 48, a pointing device 50, such as a mouse, track ball, track pad, pen device or the like, a display or screen device 52, a mass storage device 54, such as a hard drive, floppy drive, optical disk, flash memory or the like, and a network interface card or controller 56, such as an Ethernet card, and a modem 58. Client 24 communicates with other systems via network interface card 56 and/or modem 58. A variety of optional input/output devices (not illustrated) can also be attached to client 24, including printers, slide output devices, plotters, etc.

As illustrated in FIG. 3, a computer software system 64 is provided for directing the operation of client 24. Software system 64 is stored in memory 44, and on mass storage device 54. Software system 64 includes a kernel or operating system (OS) 66, and a windows shell 68. OS 66 and windows shell 68 can be provided by Microsoft® Windows 98, Microsoft® Windows NT, IBM OS/2®, Macintosh® OS, Linux®, or other similar application. One or more application programs 69, such as client application software, can be loaded for execution by client 24. In a presently preferred embodiment, client application software includes a Web browser, such as Microsoft Internet Explorer™ or Netscape Navigator™ browser software that communicates with the Internet through a communication layer or driver 70, such as a Winsock driver. Software system 64 further includes a user interface 72, preferably a graphical user interface (GUI), for receiving and displaying user inputs, commands, and data and outputs resulting from operation of operating system 66 and application programs 69.

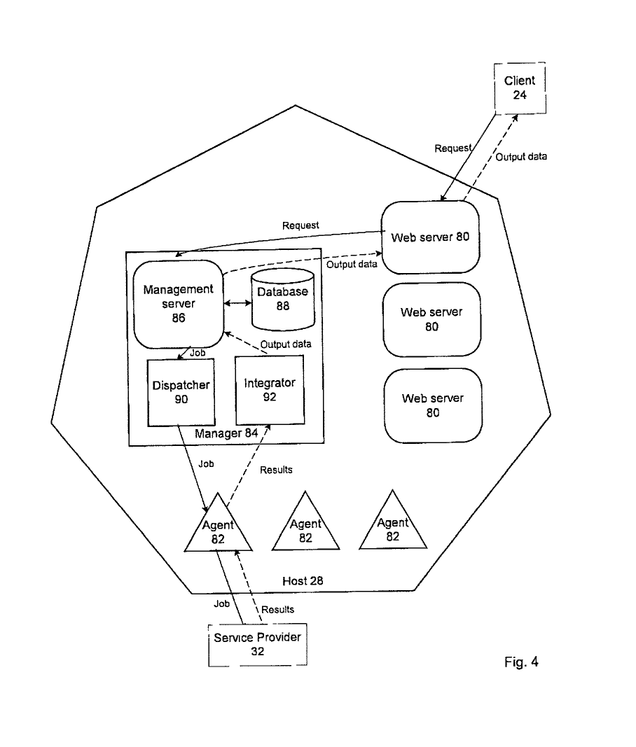

Referring to FIG. 4, host 28 generally consists of web server(s) 80, agent(s) 82, and a manager 84. Manager 84 includes a management server 86, a database storage 88, a dispatcher 90 and an integrator 92. As is well known to those of skill in the art, web servers 80 and management server 86 can each consist of one or more conventional computers having an 80586, or faster, central processing unit, such as manufactured by Intel Corporation, Santa Clara, Calif., or other similar processing unit. Each of the servers can be provided with peripheral components and software components as described above with respect to client 24. Database storage device 88 can be any suitable data storage system capable of storing and retrieving database entries, as will occur to those of skill in the art. In a presently preferred embodiment, agents 82 are software implemented entities, such as Java applets, that can interact with and monitor service providers 32. Dispatcher 90 and integrator 92 are also software implemented, and provide job dispatch and integration functions. While the components of host 28 are depicted as residing in one location, those of skill in the art will understand that they can be distributed in various locales and can communicate with each other over dedicated lines, or over Internet 36. Web servers 80, and agents 82 can be configured to connect to clients 24 and service providers 32, respectively, over Internet 36 under TCP/IP, HTTP, or other applicable protocols, as is well known to those of skill in the art.

In a presently preferred embodiment of the present invention, service providers 32 include both application servers maintained by host 28, and application servers maintained by third party alliance partners, such as universities, private corporations and government institutions, that own or maintain proprietary data analysis application programs, or analysis tools 34, and processing equipment. Such third parties enter into an agreement with host 28 to provide data analysis services whereby jobs, containing data for analysis, are submitted over Internet 36 to a respective service provider 32, which then processes the data on its own processing equipment according to a particular analysis tool, and then transmits the results of the data analysis to host 28 for delivery to a client. Generally, each service provider 32 will include a connection to Internet 36, and appropriate communications software for receiving and transmitting job information to agents 82. The particular application programs and processing equipment offered by each service provider 32 can vary, but are known to host 28.

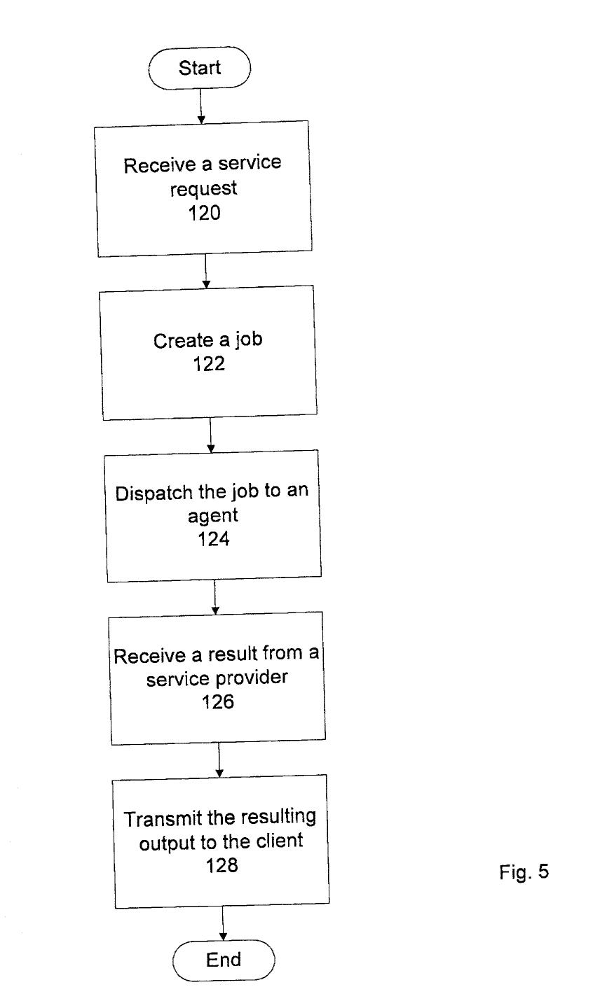

The operation of system 20, and the method of the present invention will now be described with reference to FIGS. 4-5. First, after connecting to Internet 36 in any suitable manner as is well known to those of skill in the art, a user can employ the browser software installed on client 24, to a universal resource locator (URL) identifying host 28 to provide access to a web site maintained by host 28. Once on the web site, the user will be asked to register by providing certain identification information and credit/payment information, as is well known in the art. A registered user, hereinafter referred to as a user, will then be offered a main screen listing services and links available from within the site. It is expected that such a site will offer many standard services, such as chat rooms, links to related sites, general information pages, simple “pop-up” calculators and converters, industry-specific information, standard advertising banners and menus, and other on-line features as are well known to those of skill in the art. The following discussion of the method of the present invention is, however, more specifically focussed on the provision of data analysis tools and services from within the site, and, therefore assumes that the user is registered with host 28, and has chosen a data analysis application programs function, or page, within the web site.

From the user's perspective, the user, at a client 24, selects a particular data analysis tool, and submits, or enters, data for analysis. The user then receives a job number, confirmation that the data has been submitted to the desired tool, and an expected delivery time for the results. For some tools results can be delivered to the user almost immediately, for others, there may be a waiting time of several hours or more. In the latter case, the user can choose to receive notification by e-mail, or other electronic means, that the results are available. To view or download the results, the user may need to provide the job number assigned to the job, and/or a password or other identifier.

Referring to FIGS. 4 and 5, the method begins at step 120 where host 28 receives a service request from a client 24. The service request includes input data and identifies a particular analysis tool 34 for processing the input data. In a presently preferred embodiment, the input data is entered by the user directly into a graphical user interface (GUI), or downloaded to web server 80 in a suitable format, such as an ASCII file. Web server 80 provides GUIs for data input or delivery, as appropriate.

Next, at step 122, a job is created. The job includes the input data and a job identifier. The job is created by management server 86 which is in communication with database 88. In a presently preferred embodiment, management server 86 provides a job identifier, such as a job number, to the service request. Management server 86 then marks up the input data using extensible markup language (XML) to prepare the input data for data interchange, and to append the job identifier. As is known to those of skill in the art, XML is a text-based mark up language that identifies data with tags, collectively known as “markup”. In contrast to hypertext markup language (HTML), XML identifies the data rather than defining how it should be displayed. A further advantage of XML, is that the resulting marked up data can generally pass easily through client firewalls, if such firewalls are deployed. Once created, management server 86 stores job information in database 88, and passes the job to dispatcher 90. The job information stored in database 88 can include the job identifier, identification of the client and/or user, identification of the requested analysis tool 34, time of delivery to dispatcher 90, billing information and the input data.

As shown at step 124, dispatcher 90 dispatches the job to an agent for delivery to a service provider 32 hosting the requested analysis tool 34. Dispatcher 90 sends the job to an agent 82 which monitors and controls transmission of the job, as a stream of XML packets, to service provider 32. The service provider 32 receives the job, processes the data in the requested analysis tool 34, and passes the results, in XML format, back to the agent 82. In view of the heavy processing demands that are placed on service providers 32, it is preferable that processing loads are spread as evenly as possible to all service providers 32. To this end, dispatcher 90 can perform a load balancing function, particularly where the requested analysis tool 34 resides on more than one application server, by instructing the agent 82 to transmit the job to a currently unoccupied, or lightly occupied, service provider 32.

Once the job has been processed by the service provider 32, a result of the data analysis, including appropriate output data in XML format, is received by agent 82, and transmitted to integrator 92, at step 126. Integrator 92 integrates the output data packets, updates the database entry for the job, and transmits the result, including the charges incurred for the processing, to management server 86 for delivery to client 24, at step 128.

In essence, the above-described embodiments of the system and method of the present invention provide an Internet portal for engineers, and others, seeking access to specialized data analysis application programs that would otherwise be too expensive, or of only limited availability. The present invention is a cost-effective and time-saving means of improving service within the engineering profession by providing, at reasonable cost and on a per use basis, up-to-date and highly specialized application programs and resources to anyone with Internet access. As will be appreciated by those of skill in the art, the present invention, though described in terms of engineering applications, is equally suited to use in other professions, such as accounting, management, statistics, and other applied sciences and disciplines, where access to specialized third party software and resources is desired. The above-described embodiments of the invention are intended to be examples of the present invention only, and application of the invention to disciplines other than engineering is fully within the contemplation of the present inventors. Alterations, modifications and variations may be effected to the particular embodiments by those of skill in the art, without departing from the scope of the invention which is defined solely by the claims appended hereto.

We claim:

1. A method for providing data analysis tools in a distributed environment, comprising the steps of:
(i) receiving a service request from a client, the service request including input data;
(ii) creating a job including the input data and a job identifier;
(iii) dispatching the job to an agent for delivery to a service provider hosting a requested analysis tool for processing the input data;
(iv) receiving a result from the service provider, the result including output data representing the input data processed in accordance with the requested analysis tool; and
(v) transmitting the output data to the client.

2. A method according to claim 1, wherein the steps of receiving and transmitting are accomplished over the Internet.

3. A method according to claim 1, wherein the step of dispatching the job includes formatting the input data into packets for transmission.

4. A method according to claim 3, wherein the step of formatting includes marking up the input data with extensible markup language (XML).

5. A method according to claim 1, wherein the step of creating the job includes storing job information in a database.

6. A method according to claim 1, wherein the step of dispatching includes balancing loads between application servers.

7. A method according to claim 3, wherein the step of receiving the result includes integrating received packets containing the results to recover the output data.

8. A system for providing data analysis tools in a distributed environment, comprising
a web server for receiving a service request, including input data, from a client;
a manager for creating a job including the input data and a job identifier;
a dispatcher for dispatching the job to an agent for delivery to a service provider hosting a requested analysis tool for processing the input data; and
an integrator for receiving a result from the service provider, the result including output data representing the input data processed in accordance with the requested analysis tool.

9. A system according to claim 8, further including at least one web server for connecting to the client over the Internet.

10. A system according to claim 8, wherein the manager includes a database for storing the job information.

11. A system according to claim 8, wherein the dispatcher includes load balancing means for balancing loads between service providers.

12. A system according to claim 8, wherein the manager includes markup means.

13. A system according to claim 12, wherein the markup means includes extensible mark up language (XML).

14. A system according to claim 13, wherein the integrator includes means to reassemble the job to retrieve the output data.
